(19) United States
(12) Patent Application Publication
(10) Pub. No.: US 2006/0057333 A1
(43) Pub. Date: Mar. 16, 2006

(54) Baffle precursors

(76) Inventor: Riad Brahim, Molsheim (FR)

Correspondence Address: DOBRUSIN & THENNISCH PC, 29 W LAWRENCE ST, SUITE 210, PONTIAC, MI, 48342, US

(21) Appl. No.: 10/514,610

(22) PCT Filed:
(86) PCT No.: PCT/IB03/01776

(30) Foreign Application Priority Data
May 17, 2002 (GB) 0211287.8

(51) Int. Cl. B32B 3/10

(52) U.S. Cl. 428/138; 428/140

(57) ABSTRACT

Baffle precursors are provided which comprise a sandwich of cellular plates with a foamable material therebetween these precursors overcome the problem of the flow of the foamable material as it is heated up to cause foaming which can result in non-homogeneous foam. The baffle precursors also enable uniform baffle properties to be established on both sides of the baffle and provide improved performance for a reduction in the amount of foamable material required. The hinged cellular plate is also an aspect of the invention.

The present invention relates to baffles that may be used in hollow structures such as those found in automobiles, caravans, ships, aircraft and railroad applications. The baffles are typically used to reduce noise and airflow in such hollow structures.

Baffles are typically provided to the vehicle manufacturer as a foamable material mounted on one side of a support, the support being provided with means for attachment to the inner surface of the hollow structure. The baffle with the foamable material in its unfoamed state is mounted in the hollow structure where the foamable material is subsequently foamed. The foamable material is generally foamed at elevated temperatures. Foaming to expand the material and fill the cross section of the hollow structure is therefore accomplished by heating the hollowing structure. In a preferred embodiment the foaming is accomplished during the drying and baking process following the immersion of the hollow structure in an anticorrosion bath such as in the e coat process used in automobile manufacture.

In this way the anticorrosion coating may reach all the surfaces of the hollow structure and the foaming may be accomplished after the anticorrosion treatment.

In order to have sufficient expansion to provide an economic and effective baffle the foamable material should have a high degree of expansion typically from 700 to 1000%. In order for this to be accomplished the foamable materials are generally soft and have a low melt viscosity. This in turn means that they can flow readily when heated which may lead to sag under gravity resulting in a non-uniform foam structure. An additional concern is that in some processes involving the electrocoat process the structure is subject to a two stage baking process involving an initial pre-bake oven operating at a lower temperature and a subsequent higher temperature oven. In processes of this nature there can also be the problem that the foamable material will start to flow in the initial oven and may fall under gravity thus providing a layer of non-uniform thickness for the foaming in the subsequent oven resulting in non-homogenous foaming, uneven foam and uneven baffle properties.

The foamable material is typically an ethylene copolymer such as an ethylene vinyl ester or ethylene acrylate ester copolymer or it may be an ethylene propylene copolymer or ethylene, propylene diene copolymer rubber. One difficulty that arises with the existing technology as described is that the foamable material has a low viscosity as its temperature is increased to the foaming temperature. Accordingly,since it is unusual for a baffle to be mounted in a location where foaming takes place vertically upwards the foamable material tends to flow downwards under gravity as the temperature is increased. This leads to a non-uniform thickness of the foam and also the need to use larger amounts of the foamable material to ensure adequate thickness of the foam at the thinner upper regions of the baffle.

It has also not been possible to provide baffles which have foamable material on both sides of a support to enable foam to be provided on both sides of the support. Further it has been necessary to produce separate baffles for use in for example the left and right sides of a vehicle.

We have now found that these difficulties may be overcome if the baffle precursor is a sandwich structure comprising surface plates having a cellular structure and an inner layer of foamable material.

The present invention therefore provides a baffle precursor comprising a pair of support plates at least one of whose surfaces has a cellular structure with a foamable material contained between the plates wherein the cellular structure is such that when foamed the foamable material expands and passes through the cellular structure of the plates and expands so that the entire outer surface of the cellular support plate is covered with foam.

In a preferred embodiment both surfaces of the support plate are cellular and the foamable material provides a foam covering both outer surfaces. The baffles will therefore have foam on both sides of the support. Furthermore, the baffles will have comparable performance in terms of sound reduction and airflow reduction on both sides of the baffle which has hitherto not been possible. The invention also provides single baffle precursors that may be used to produce baffles on both the left and right side of automobiles.

The optimum cellular structure for the plates will depend upon the nature of the foamable material, the environment within which the baffles are to be used, the amount of foamable material to be used and the final desired foam volume. The use of the cellular structure in the plates has the advantage that as the foam expands through the cells and into the air it will present a large surface area. This large area will be cooled rapidly thus providing integrity to foam rapidly upon foam formation. This, in turn reduces the tendency of the foaming or foamed material to flow other than due to the foaming action. The walls of the cells (or holes) in the plates will also provide mechanical keys for the foam which will also reduce its tendency to flow under gravity.

The plates having the cellular structure should be made of materials which will withstand the temperatures that are used to foam the foamable material. In a preferred embodiment of the present invention, the foaming temperature is the temperature of the curing oven in the electrocoat process used in automobile manufacture. This is typically between 130° C. and 200° C., more typically between 150° C. and 170° C. The plates may therefore be made of any suitable material which can withstand these temperatures. Suitable materials include metals and high melting thermoplastics such as polyamide which may or may not be reinforced with fibres such as glass fibres, carbon fibres and metal fibres. The thickness of the plates will depend upon the environment in which the baffle is to be used however, we prefer to use plates of thickness from 0.5 to 2.5 mm more preferably from 1 to 1.5 mm.

The cellular structure may consist of a series of holes in the plates or may be any other design to match the needs of the system.

The nature and thickness of the core of the foamable material will depend upon the circumstances. However we prefer that the foamable material be a thermoplastic material such as a copolymer of ethylene and a vinyl and/or acrylic ester such as vinyl acetate, vinyl propionate, methyl acrylate, ethyl acrylate and butyl acrylate. Alternatively the foamable material may be a rubbery polymer such as an ethylene propylene copolymer rubber or more desirably an ethylene, propylene diene terpolymer rubber. The material will contain a blowing agent and perhaps an activator to ensure that the material foams at the desired temperature. In addition the material may contain other additives such as stabilisers and antioxidants.

The foamable material preferably has a thickness of from 2 to 6 mm, preferably from 3 to 5 mm and we have found that the techniques of the present invention enable improved baffle performance and produce a more homogenous foam on both sides of the baffle when compared with previous systems which employed a 5 to 10 mm, more typically 5 to 8 mm thick layer of foamable material to produce a baffle having foam and acoustic properties on one side of the baffle only. Accordingly an additional benefit of the present invention is that comparable or better baffle performance may be obtained using less foamable material.

The amount of foamable material should, however, be such that a continuous foam layer is formed after the foamable material has egressed through the cellular structure. As the foam egresses through the cells (or holes) in the plate it will form mushroom like structures based on each cell (or hole). These mushroom like structures will expand as more foamable material pushes through the cells. Whilst it is not important that the mushroom like structures fully integrate with each other it is important that they are in contact and bond in a manner that provides a continuous foam layer to provide the desired barrier to air flow.

The baffle should be provided with a means for attachment within the hollow structure. The attachment may be part of the baffle which engages with the internal surface of the hollow structure, for example, it may be a clip which is designed to fit into a hole in the internal surface of the hollow structure. In this instance the clip or clips may conveniently be integral with one or more of the plates of the baffle precursor.

Alternatively the attachment means, such as a clip may be formed on the internal surface of the hollow structure and the baffle itself provided with means to engage with the clip. Hereagain these means may be integral with one or more of the plates of the baffle precursor and where the plates are formed by injection moulding they may be integrally moulded.

In a preferred embodiment the two plates are joined by a hinge so that they can be superimposed upon each other with the foamable material there between. In a further preferment of this embodiment the attachment means may be a clip and may be such that part of the clip is integral with one plate of the baffle and another part of the clip is integral with the other plate of the baffle. The two parts of the clip being such that when the plates are superimposed upon each other they engage with each other to hold the two plates in position and also to form the clip that can be inserted into a hole in the internal surface of the hollow structure to hold the baffle precursor in place. According to the needs of the structure one or more attachment clips may be provided in this manner.

Accordingly in another embodiment the invention provides a plate system for use in the production of baffles for attachment within hollow structures comprising two plates hinged so that they may be superimposed upon each other, each plate having a cellular structure and each plate carrying part of an attachment means whereby the attachment means is formed when the plates are superimposed and the parts of the attachment means engage to hold the plates together.

It is preferred that the plate system be integrally moulded from thermoplastic materials, glass filled polyamide or polypropylene being particularly preferred due to their ability to form moulded hinges.

The foamable material may be provided between the plate structure as a cut or stamped strip or by spot deposition or other suitable means.

The present invention is illustrated by reference to the accompanying schematic drawings in which:

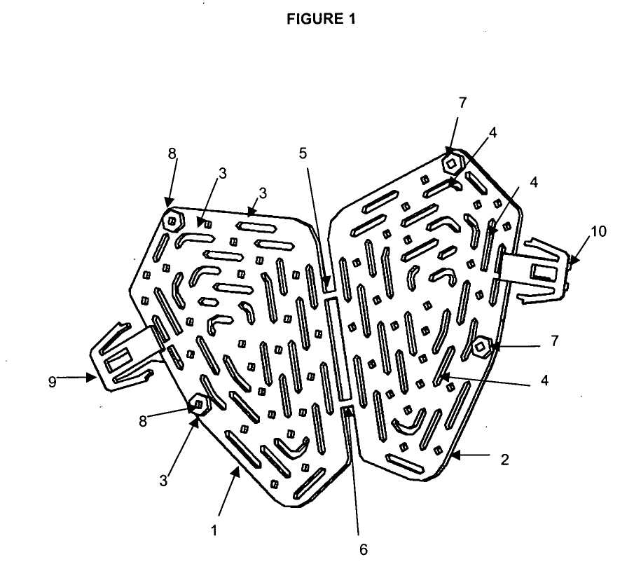

FIG. 1 shows a plate system according to the present invention that can be used in the production of the baffle precursors of the invention. The plate system consists of two plates (1) and (2) each of which are provided with a series of holes designated (3) in plate (1) and (4) in plate (2). The plates are joined by integrally moulded hinges (5) and (6). Stops (7) and (8) are also provided on the plates to provide a gap of predetermined thickness between the plates when they are superimposed. The gap is for the layer of foamable material. A part (9) of an attachment clip is integral with plate (1) and another part (10) of the attachment chip is integral with plate (2).

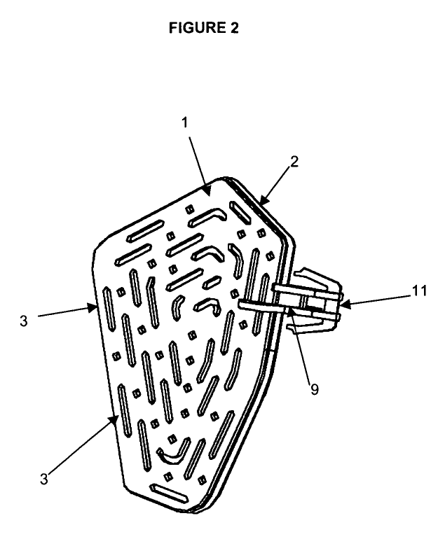

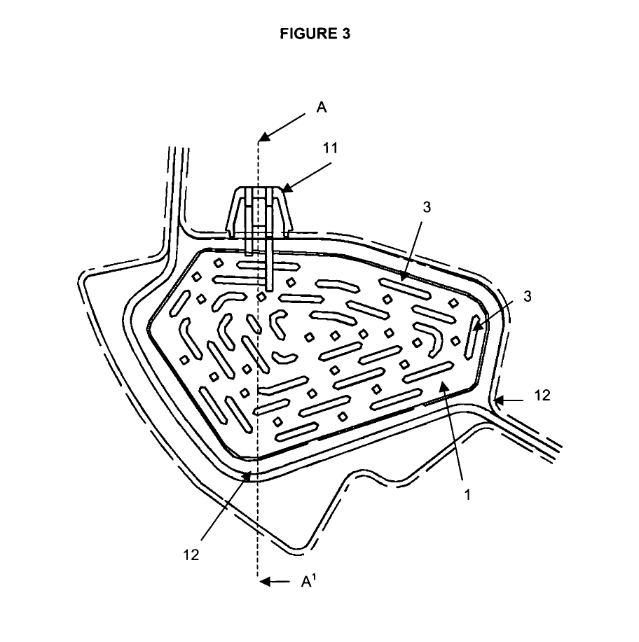

FIG. 2 shows how the two plates of the plate system of FIG. 1 may be superimposed to form a sandwich structure baffle precursor with a foamable material (not shown) between the plates and provided with an integral clip (11) for attachment to the internal surface of a hollow member. FIG. 3 shows the baffle precursor shown in FIG. 3 mounted within a hollow structure (12) which may for instance be a pillar such as an A, B or C pillar of an automobile.

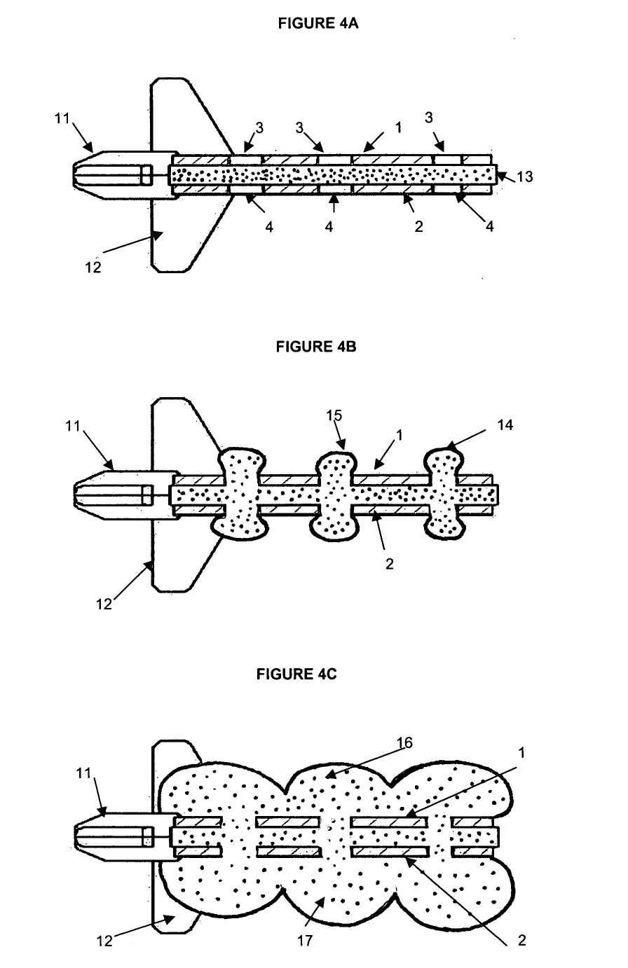

FIG. 4B is a cross section through the line A-A¹ of FIG. 3 showing the foamable layer (13) between Plates (1) and (2).

FIG. 4C shows the baffle precursor of FIG. 4A after foaming has commenced.

FIG. 4B shows the baffle produced from the precursor of FIG. 4A when foaming is complete.

FIG. 4A shows the pair of plates (1) and (2) each of which is provided with a series of holes designated (3) in plate (1) and (4) in plate (2). Sandwiched between plates (1) and (2) is a layer of foamable material (13). The baffle precursor of FIG. 4A is attached within the hollow structure (12) by the clip (11).

The system shown in FIG. 4A may then be heated so that the foamable material (13) begins to expand as shown in FIG. 4B. As the foamable material (13) begins to expand it will egress through the holes (3) and (4) (shown in FIG. 4A) and will emerge initially as mushroom shaped structures (14) and (15) through plates (1) and (2) respectively. The large surface area of the mushroom structure will enhance the cooling of the foaming material and reduce its tendency to flow. Furthermore the extremities of the holes (3) and (4) will provide a mechanical key for the foam.

FIG. 4C illustrates how upon further expansion the mushrooms (14) and (15) grow so that they overlap and interact to provide a foam structure (16) and (17) over both sides of the entire area of the baffle and filling the cavity provided by the hollow structure (12).

The techniques of the present invention therefore enable the production of a baffle having a more uniform foam structure, having equal baffle properties on two sides and produced from a smaller amount of foamable material.

1-13. (canceled)

14. A baffle precursor comprising:
a pair of support plates including a first support plate and a second support, the first support plate having a cellular structure and having an outer surface;
a foamable material located between first support plate and the second second support plate;
wherein, upon foaming, the foamable material expands and passes through the cellular structure of the first plate and expands to form a foam that substantially covers the entire outer surface of the first support plate.

15. A baffle precursor as in claim 14 wherein the foamable material expands upon encountering an elevated temperature.

16. A baffle precursor as in claim 15 wherein the first plate and the second plate are formed of materials which will withstand the elevated temperature.

17. A baffle precursor as in claim 16 wherein the elevated temperature is between 130° C. and 200° C.

18. A baffle precursor as in claim 16 wherein the elevated temperature is a temperature typically experienced in an automotive paint or e-coat oven.

19. A baffle precursor as in claim 16 wherein the first and second plates are formed of a material selected from a metal or a high melting thermoplastic.

20. A baffle precursor as in claim 19 wherein the material is a polyamide reinforced with fibres selected from glass fibres, carbon fibres and metal fibres.

21. A baffle precursor as in claim 14 wherein the first plate and the second plate each have a thickness from 0.5 mm to 2.5 mm.

22. A baffle precursor as in claim 14 wherein the first plate and the second plate each have a thickness from 1.0 mm to 1.5 mm.

23. A baffle precursor as in claim 14 wherein the foamable material is selected from a thermoplastic material or a rubbery polymer and wherein the thermoplastic material is selected from a compolymer of ethylene and a vinyl ester or acrylic ester and wherein the vinyl ester or acrylic ester is selected from vinyl acetate, vinyl propionate, methyl acrylate, ethyl acrylate and butyl acrylate and wherein the rubbery polymer is selected from an ethylene propylene copolymer rubber and an ethylene, propylene dieneter polymer rubber.

24. A baffle precursor as in claim 14 wherein the precursor includes an attachment for locating the prescursor within a hollow structure.

25. A baffle precursor as in claim 14 wherein the foamable material is contained between the pair of support plates.

26. A baffle precursor as in claim 14 wherein the first plate is hinged to the second plate and each of the first and second plates includes a portion of an attachment and the portion of the first plate engages the portion of the second plate and attach to each other to hold the plates together in a superimposed relationship.

27. A baffle precursor comprising:
a pair of support plates including a first support plate and a second support plate, the first support plate and the second support plate having a cellular structure and having an outer surface, wherein the first plate is superimposed upon the second plate;
a foamable material located and contained between first support plate and the second second support plate;
wherein, upon foaming, the foamable material expands and passes through the cellular structure of the first plate and the second plate and expands to form a foam that substantially covers the entire outer surface of the first support plate and the second plate.

28. A baffle precursor as in claim 27 wherein the first plate and the second plate are formed of materials which will withstand an elevated temperature between 130° C. and 200° C.

29. A baffle precursor as in claim 27 wherein the first and second plates are formed of a polyamide reinforced with fibres selected from glass fibres, carbon fibres and metal fibres.

30. A baffle precursor as in claim 27 wherein the first plate and the second plate each have a thickness from 1.0 mm to 1.5 mm.

31. A baffle precursor as in claim 27 wherein the foamable material is selected from a thermoplastic material or a rubbery polymer and wherein the thermoplastic material is selected from a compolymer of ethylene and a vinyl ester or acrylic ester and wherein the vinyl ester or acrylic ester is selected from vinyl acetate, vinyl propionate, methyl acrylate, ethyl acrylate and butyl acrylate and wherein the rubbery polymer is selected from an ethylene propylene copolymer rubber and an ethylene, propylene dieneter polymer rubber.

32. A baffle precursor as in claim 27 wherein the precursor includes an attachment for locating the prescursor within a hollow structure.

33. A baffle precursor as in claim 27 wherein the first plate is hinged to the second plate and each of the first and second plates includes a portion of an attachment and the portion of the first plate engages the portion of the second plate and attach to each other to hold the plates together in a superimposed relationship.

34. A baffle precursor comprising:
a pair of support plates including a first support plate and a second support plate, the first support plate and the second support plate having a cellular structure and having an outer surface, wherein the first plate is superimposed upon the second plate;
a foamable material located between first support plate and the second second support plate;
wherein, upon foaming, the foamable material expands and passes through the cellular structure of the first plate and the second plate and expands to form a foam that substantially covers the entire outer surface of the first support plate and the second plate; and
wherein the foamable material expands upon encountering an elevated temperature;
wherein the first plate and the second plate are formed of materials which will withstand the elevated temperature;
wherein the elevated temperature is a temperature typically experienced in an automotive paint or e-coat oven;
wherein the first and second plates are formed of a material selected from a polyamide reinforced with fibres selected from glass fibres, carbon fibres and metal fibres;
wherein the first plate and the second plate each have a thickness from 1.0 mm to 1.5 mm; and
wherein the foamable material is selected from a thermoplastic material or a rubbery polymer and wherein the thermoplastic material is selected from a compolymer of ethylene and a vinyl ester or acrylic ester and wherein the vinyl ester or acrylic ester is selected from vinyl acetate, vinyl propionate, methyl acrylate, ethyl acrylate and butyl acrylate and wherein the rubbery polymer is selected from an ethylene propylene copolymer rubber and an ethylene, propylene dieneter polymer rubber;
wherein the precursor includes an attachment for locating the prescursor within a hollow structure;
wherein the foamable material is contained between the pair of support plates; and
wherein the first plate is hinged to the second plate and each of the first and second plates includes a portion of an attachment and the portion of the first plate engages the portion of the second plate and attach to each other to hold the plates together in a superimposed relationship.
